(19) United States
(12) Patent Application Publication
(10) Pub. No.: US 2012/0235437 A1
(43) Pub. Date: Sep. 20, 2012

(54) VEHICLE DOOR TRIM AND METHOD FOR MANUFACTURING VEHICLE DOOR TRIM

(75) Inventors: Ryousuke SAKAMAKI, Toyohashi-shi (JP); Manabu MIYAMOTO, Hamamatsu-shi (JP)

(73) Assignee: ASMO CO., LTD., Shizuoka-ken (JP)

(21) Appl. No.: 13/418,118

(22) Filed: Mar. 12, 2012

(30) Foreign Application Priority Data
Mar. 15, 2011 (JP) 2011-056850
Nov. 18, 2011 (JP) 2011-252819

(51) Int. Cl. B60R 13/02; B23P 11/00

(52) U.S. Cl. 296/1.08; 29/428

(57) ABSTRACT

A vehicle door trim is adapted for being attached to a vehicle that has a fixed body having an opening and a movable body for opening and closing the opening. The door trim is attached along a trim attaching part of at least one of the fixed body and the movable body. When the movable body is in a closed state, the door trim is located between the movable body and the fixed body. The door trim has integrally formed attaching portions for being attached to the trim attaching part. The attaching portions are arranged along a longitudinal dimension at predetermined intervals.

### BACKGROUND OF THE INVENTION

The present invention relates to a vehicle door trim, which is attached to a fixed body having an opening or attached to a vehicle door, which is a movable body for opening and closing such an opening of a fixed body. The present invention also relates to a method for manufacturing the vehicle door trim.

Japanese Laid-Open Patent Publication No. 11-72395 discloses a conventional vehicle door panel attached to a door panel, which is a movable body of a sliding door. The vehicle door trim according to the publication is formed by an elongated rubber member and is attached to a door panel along a trim attaching part provided on the front edge of the door panel. The door trim has a single substantially U-shaped attaching portion, which is assembled to a single attaching piece (a flange in the above publication) provided at the trim attaching part. When the door panel is in a closed state, the door trim is located between the door trim attaching part of the door and the center pillar, which is a fixed body.

The trim attaching part of a door panel (or a center pillar), to which the door trim as described above is attached, has a shape in accordance with the shape of the door. Depending on the type of a vehicle, the trim attaching part is curved in the vehicle width direction. In such a case, if the attaching portion of the door trim is formed to be continuous in the longitudinal direction of the door trim, it is difficult to attach the door trim attaching portion to the curved section of the door trim attaching part. Thus, there is still room for improvement in this regard.

### SUMMARY OF THE INVENTION

Accordingly, it is an objective of the present invention to provide a vehicle door trim that can be easily attached to a trim attaching part and a method for manufacturing the door trim.

To achieve the foregoing objective and in accordance with a first aspect of the present invention, an elongated vehicle door trim is provided that is adapted for being attached to a vehicle that has a fixed body having an opening and a movable body for opening and closing the opening. The door trim is attached along a trim attaching part of at least one of the fixed body and the movable body. When the movable body is in a closed state, the door trim is located between the movable body and the fixed body. The door trim comprises a plurality of attaching portions for being attached to the trim attaching part. The attaching portions are arranged along a longitudinal dimension of the door trim at predetermined intervals and formed integrally with the door trim.

In accordance with a second aspect of the present invention, a method for manufacturing an elongated vehicle door trim is provided. The door trim is adapted for being attached to a vehicle that has a fixed body having an opening and a movable body for opening and closing the opening. The door trim is adapted for being attached along a trim attaching part of at least one of the fixed body and the movable body such that when the movable body is in a closed state, the door trim is located between the movable body and the fixed body. The method comprising forming a plurality of attaching portions for being attached to the trim attaching part such that the attaching portions are formed integrally with the door trim and such that the attaching portions are arranged along a longitudinal dimension of the door trim at predetermined intervals.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view illustrating an electric sliding door apparatus with a door trim according to one embodiment of the present invention;

FIG. 2 is a side view illustrating a vehicle with the electric sliding door apparatus;

FIG. 3 is a schematic diagram illustrating the door panel as viewed from the front;

FIG. 4 is a block diagram showing the electrical configuration of the electric sliding door apparatus;

FIG. 5 is a cross-sectional view illustrating the door trim according to the embodiment;

FIG. 6A is a perspective view illustrating the door trim according to the embodiment after being formed by extrusion;

FIG. 6B is a perspective view illustrating the door trim according to the embodiment;

FIG. 7A is a cross-sectional view illustrating a door trim according to a modification;

FIG. 7B is an exploded perspective view illustrating the door trim according to the modification of FIG. 7A;

FIG. 8A is a cross-sectional view illustrating a door trim according to a modification;

FIG. 8B is an exploded perspective view illustrating the door trim according to the modification of FIG. 8A;

FIG. 9A is a cross-sectional view illustrating a door trim according to a modification;

FIG. 9B is a perspective view illustrating the door trim according to the modification of FIG. 9A;

FIG. 10 is a schematic diagram illustrating a door panel according to a modification, as viewed from the front;

FIG. 11 is a side view illustrating a door trim according to a modification; and

FIG. 12 is a cross-sectional view illustrating a door trim according to a modification.

### DETAILED DESCRIPTION OF THE PREFERRED EMBODIMENTS

A sliding door for a vehicle according to one embodiment of the present invention will now be described with reference to the drawings.

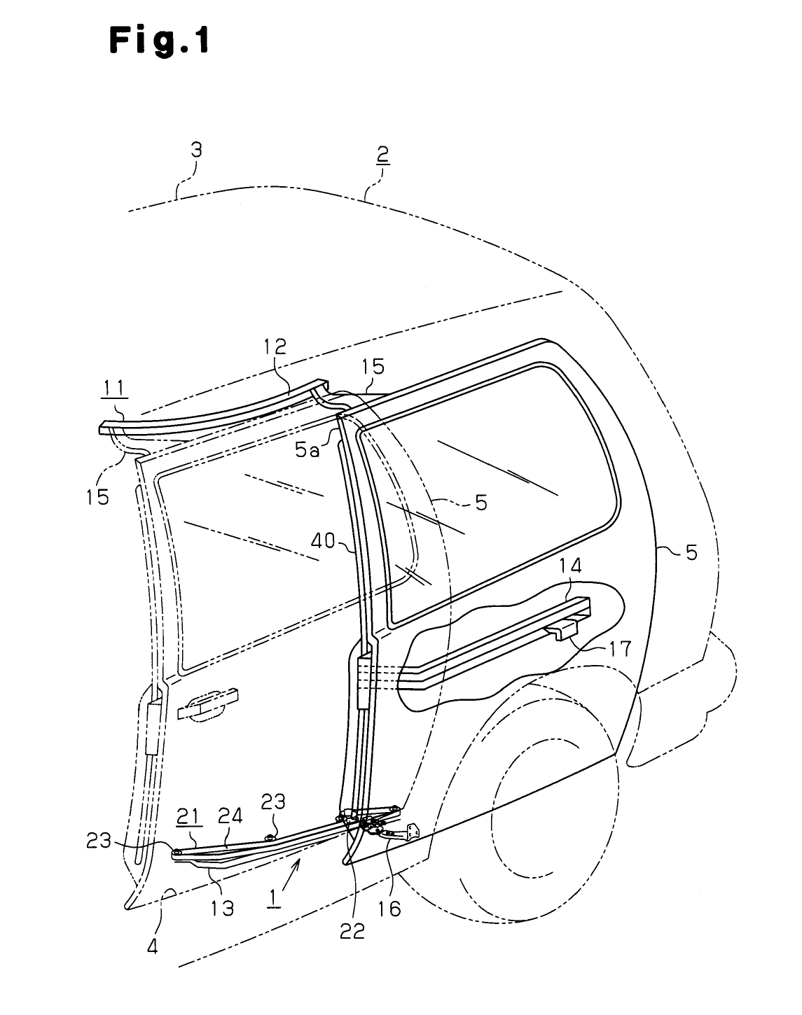

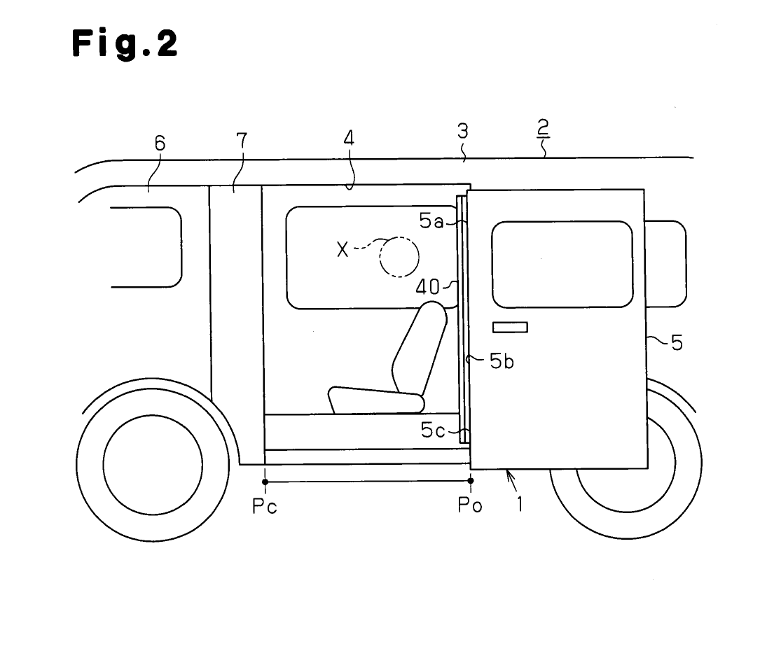

As shown in FIG. 1, a vehicle 2 equipped with an electric sliding door apparatus 1 has a vehicle body 3 (fixed body) made of an electrically conductive metal. A substantially rectangular entry/exit opening 4 is formed in a left side of the vehicle body 3. The entry/exit opening 4 is formed in an electrically-conductive metal, and opened and closed by a door panel 5 (movable body), which has a substantially rectangular shape corresponding to the entry/exit opening 4. As shown in FIG. 2, a conductive front passenger seat-side door panel 6 is provided in front of the entry/exit opening 4. A conductive center pillar 7, which extends in the vertical direction of the vehicle 2, is provided between the door panel 5 in a state closing the entry/exit opening 4 and the front passenger seat-side door panel 6.

As shown in FIG. 1, the door panel 5 is attached to the vehicle body 3 with an actuating mechanism 11. The rear door panel 5 is movable in the forward-rearward direction so as to open and close the entry/exit opening 4.

The actuating mechanism 11 includes an upper rail 12, a lower rail 13, and a center rail 14. The upper rail 12 and the lower rail 13 are respectively provided in an upper portion and a lower portion of the entry/exit opening 4 in the vehicle 2. The center rail 14 is provided centrally in the vertical direction at a location rearward of the entry/exit opening 4 in the vehicle 2. Each of the rails 12 to 14 is formed to extend from the rear end toward the front end thereof in the forward-rearward direction of the vehicle 2, and is inclined such that a front portion thereof is curved toward the interior of the passenger compartment.

An upper arm 15 is fixed to an upper part of the inner surface of the door panel 5 facing the passenger compartment. A lower arm 16 is fixed to the passenger compartment-facing inner surface. A center arm 17 is fixed to a predetermined position in a center portion of the passenger compartment-facing inner surface. The upper arm 15 is coupled to the upper rail 12. The lower arm 16 is coupled to the lower rail 13. The center arm 17 is coupled to the center rail 14. The arms 15 to 17 are respectively guided by the rails 12 to 14 so as to be movable in the forward-rearward direction of the vehicle 2.

The lower arm 16 is moved in the forward-rearward direction of the vehicle 2 by a drive mechanism 21. More specifically, the drive mechanism 21 includes a drive pulley 22 and driven pulleys 23 on a side of the lower rail 13 facing the passenger compartment. The pulleys 22, 23 are each rotatable about an axis extending in the vertical direction of the vehicle 2. An endless belt 24 is wound around the drive pulley 22 and the driven pulleys 23. A distal end portion of the lower arm 16 is fixed to the endless belt 24. As shown in FIGS. 1 and 4, a slide actuator 25, which forms a part of the drive mechanism 21, is connected to the drive pulley 22. The slide actuator 25 is located in the passenger compartment. The slide actuator 25 is provided with a slide motor 26 and a speed reducing mechanism (not shown), which reduces the speed of rotation of the slide motor 26. When the slide motor 26 is driven, the drive pulley 22 is rotated. Then, the endless belt 24 is rotated to move the lower arm 16 in the forward-rearward direction. The rear door panel 5 is thus slid in the forward-rearward direction.

As shown in FIG. 4, a position detector 27 for detecting rotation of the slide motor 26 is arranged in the slide actuator 25. The position detector 27 is formed, for example, by a permanent magnet (not shown) and a Hall IC (not shown). The permanent magnet rotates integrally with the rotary shaft (not shown) of the slide motor 26 or with the reducing gear (not shown) of the speed reducing mechanism, and the Hall IC is arranged to face the permanent magnet. The Hall IC outputs, as position detection signals, pulse signals in accordance with changes in the magnetic field of the permanent magnet caused by rotation of the permanent magnet.

As shown in FIGS. 2 and 4, the electric sliding door apparatus 1 includes an operation switch 31, which commands opening and closing of the door panel 5. When an operator such as an occupant of the vehicle 2 operates the operation switch 31 to open the entry/exit opening 4, the operation switch 31 outputs an opening signal for sliding the rear door panel 5 to open the entry/exit opening 4. On the other hand, when an operator such as an occupant of the vehicle 2 operates the operation switch 31 to close the entry/exit opening 4, the operation switch 31 outputs a closing signal for sliding the rear door panel 5 to close the entry/exit opening 4. The operation switch 31 is provided, for example, in a predetermined portion (for example, in the dashboard) within the passenger compartment, on the door lever (not shown) of the rear door panel 5, or in a portable item (not shown) carried together with the ignition key.

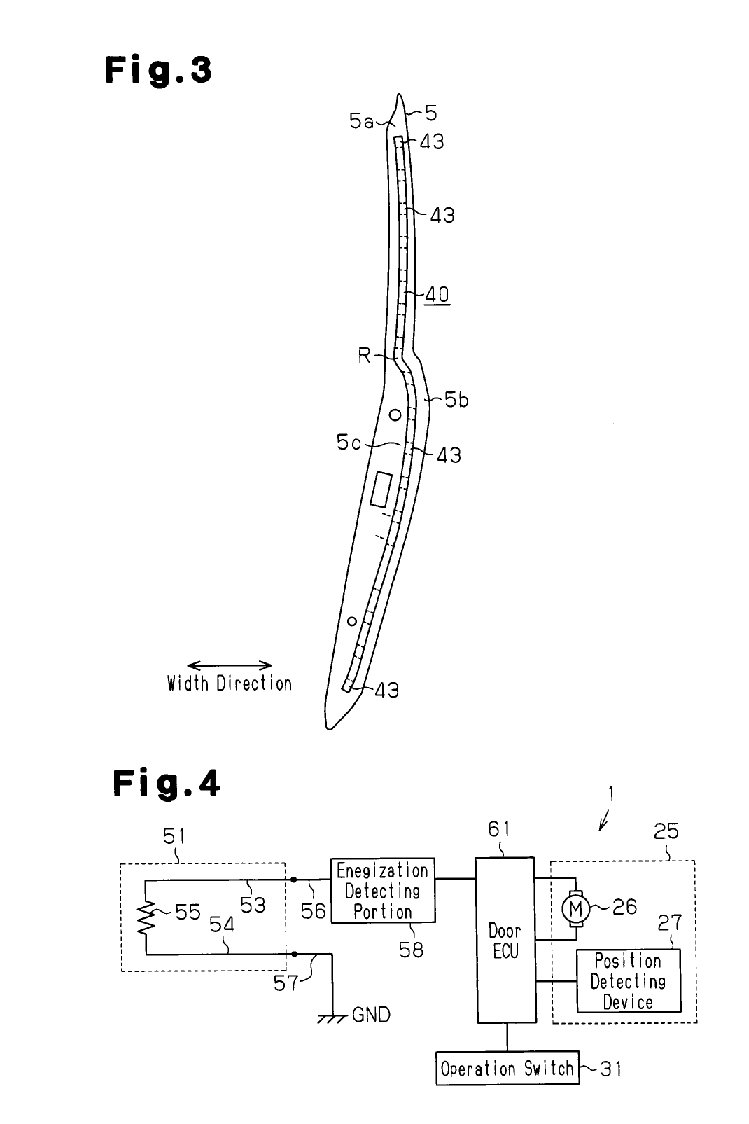

A front edge 5a (edge on the front end in the vehicle 2) of the door panel 5 is made of a hard metal member. The electric sliding door apparatus 1 as described above includes a flat plate-like trim attaching part 5b, which is attached to the front edge 5a of the door panel 5 as shown in FIGS. 2 and 3. The trim attaching part 5b is substantially parallel with a vertical surface that extends in the left-right direction of the vehicle. The trim attaching part 5b has an elongated shape extending in the vertical direction of the vehicle 2. An attaching surface 5c is formed at an end face on the side of the trim attaching part 5b facing the front of the vehicle. A vehicle door trim (hereafter, simply referred to as a door trim) 40 is attached to the attaching surface 5c.

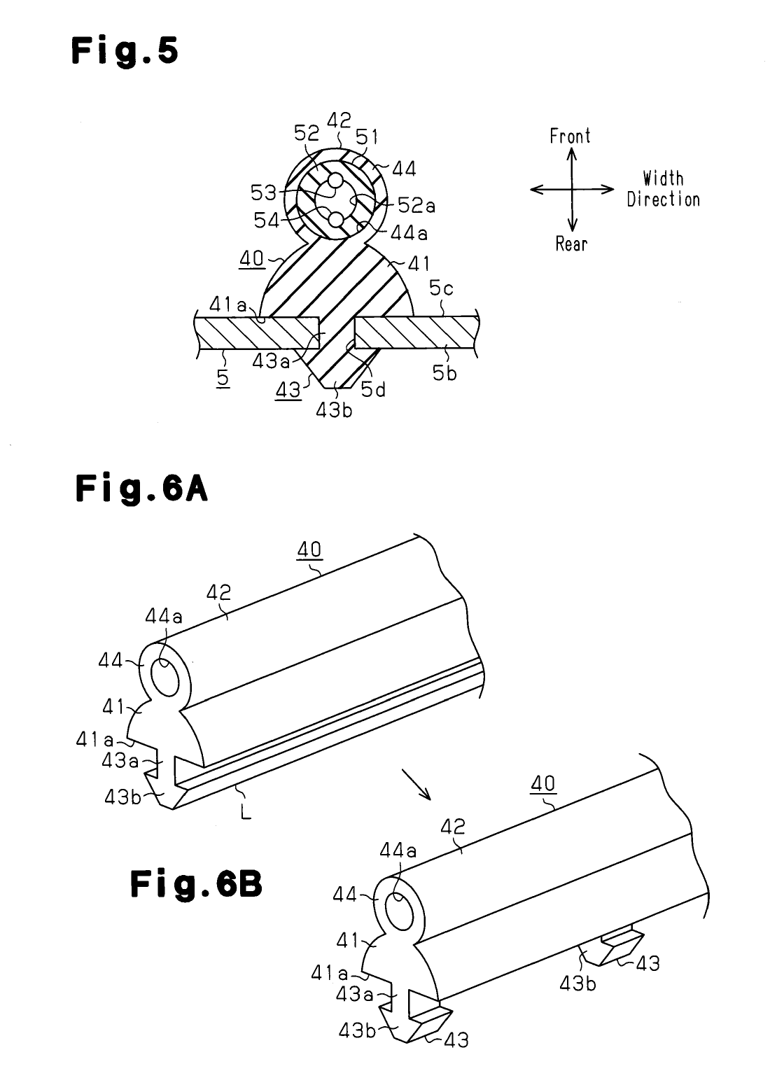

The door trim 40 has an elongated shape and has a length that is substantially equal to the length of the door panel 5 (the trim attaching part 5b) in the vertical direction. As shown in FIG. 5, the door trim 40 has a base 41 and a sensor portion 42, which are formed integrally. The door trim 40 is fixed to the trim attaching part 5b, and the sensor portion 42 protrudes toward the front end of the vehicle from the base 41. The base 41 has a substantially semi-circular cross section perpendicular to the longitudinal direction. The sensor portion 42, which has a circular cross section, is formed integrally with the arcuate front end face of the base 41. A flat end face 41a of the base 41 that faces the rear of the vehicle, on the other hand, contacts the attaching surface 5c of the trim attaching part 5b. A plurality of locking projections 43 (attaching portions) are formed on the flat end face 41a.

As shown in FIG. 3, the locking projections 43 are spaced apart at equal intervals in the longitudinal direction of the door trim 40.

As shown in FIG. 5, each locking projection 43 is formed by an extended portion 43a, which is extended toward the rear of the vehicle from the flat end face 41a of the base 41, and a trapezoidal locking portion 43b formed at the distal end of the extended portion 43a. The locking portion 43b is wider than the extended portion 43a in the vehicle width direction. That is, the locking portion 43b protrudes in the vehicle width direction from the distal end of the extended portion 43a, that is, from the rear end. The locking portion 43b has a tapered shape such that its dimension in the width direction reduced toward the distal end, or toward the rear end. The locking projections 43 are formed at center of the flat end face 41a of the base 41 with respect to the vehicle width direction.

A plurality of locking holes 5d are formed in and extend through the trim attaching part 5b. The locking holes 5d are spaced apart at equal intervals in the longitudinal direction of the trim attaching part 5b. Each locking hole 5d receives one of the locking projections 43 of the door trim 40. The locking portion 43b at the distal end of each locking projection 43 is locked to the back of the trim attaching part 5b, that is, locked to the end face opposite to the attaching surface 5c. This fixes the door trim 40 to the trim attaching part 5b. When installing the door trim 40, the door trim 40 is pressed in a direction toward the rear of the vehicle, against the trim attaching part 5b, so that the locking projections 43 are inserted into the locking holes 5d.

The door trim 40 of the present embodiment is installed while being curved in the vehicle width direction to correspond to the shape of the front edge 5a of the door panel 5 as shown in FIG. 3. The locking projections 43 of the door trim 40 are not located at a curved section R of the door trim 40.

The sensor portion 42 of the door trim 40 is used for detecting a foreign object X (see FIG. 2), which is located between the front edge 5a (closing edge) of the door panel 5 and an edge of the entry/exit opening 4. The sensor portion 42 includes a tubular sensor holding portion 44, which extends in the longitudinal direction of the door trim 40. A hollow portion 44a, which has a circular cross section, is formed in the center of the sensor holding portion 44 to extend in the entire longitudinal direction of the door trim 40. An elongated foreign object detection sensor 51 is received in the hollow portion 44a of the sensor holding portion 44. The foreign object detection sensor 51 has a length substantially equal to the length of the sensor portion 42 in the longitudinal direction.

The foreign object detection sensor 51 includes a hollow insulator 52. The hollow insulator 52 is formed of a tubular insulating material that has insulation properties and restoring characteristics and can be elastically deformed. The hollow insulator 52 is formed, for example, of soft plastic material, which is, for example, rubber. A separation hole 52a is formed in the radial center of the hollow insulator 52. The separation hole 52a is a through hole extending along the entire longitudinal dimension of the hollow insulator 52.

A pair of detection electrodes 53, 54 are arranged inside and held by the hollow insulator 52. The detection electrodes 53, 54 each include a flexible core electrode and a tubular elastic conductive coating layer (neither is shown). The core electrode is formed by twining conductive fine lines, and coated with the conductive coating layer. The two detection electrodes 53, 54 are arranged in the hollow insulator 52 separated from each other and extend helically along the longitudinal dimension of the hollow insulator 52. In the present embodiment, the pair of detection electrodes 53, 54 located inside the hollow insulator 52 face each other in a radial direction of the hollow insulator 52 at any position in the longitudinal direction of the hollow insulator 52. Approximately half the circumference of each of the detection electrodes 53, 54 is embedded in the hollow insulator 52.

Also, as shown in FIG. 4, one end of the detection electrode 53 and one end of the detection electrode 54 are drawn out of one end of the hollow insulator 52 in the longitudinal direction, and are connected to a resistor 55 (a diagnostic resistor). The other end of the detection electrode 53 and the other end of the detection electrode 54, which are drawn out of the other end of the hollow insulator 52 in the longitudinal direction, are connected to feeder cables 56, 57 for supplying electricity to the detection electrodes 53, 54, respectively.

The feeder cables 56, 57 are drawn into the door panel 5. The feeder cable 56, which is connected to the detection electrode 53, is electrically connected to a current passage detecting portion 58 (see FIG. 4). The feeder cable 57, which is connected to the detection electrode 54, is connected to the ground GND, or grounded to the vehicle body.

As shown in FIG. 4, the current passage detecting portion 58, which is a part of the foreign object detection sensor 51, supplies electric current to the detection electrode 53 through the feeder cable 56. When no pressing force is applied to the foreign object detection sensor 51, the current supplied from the current passage detecting portion 58 to the detection electrode 53 flows to the detection electrode 54 through the resistor 55. In contrast, when a pressing force acts on the foreign object detection sensor 51 to depress the sensor 51 in a radial direction, the hollow insulator 52 is elastically deformed in an integral manner. The elastic deformation of the hollow insulator 52 bends the detection electrodes 53, 54 so that the detection electrodes 53, 54 contact and are short-circuited with each other. The current supplied from the current passage detecting portion 58 to the detection electrode 53 flows to the detection electrode 53 without flowing through the resistor 55. Thus, for example, in a case where a current is supplied at a constant voltage to the detection electrode 53, the current changes when the sensor is depressed. Thus, the current passage detecting portion 58 detects such a change in the current value, thereby detecting that a pressing force has been applied to the foreign object detection sensor 51. When detecting a change in the current value, the current passage detecting portion 58 outputs a contact detection signal to a door electronic control unit (ECU) 61 discussed below. When pressing force acting on the foreign object detection sensor 51 is removed, the hollow insulator 52 returns to the original shape, so that the detection electrodes 53, 54 return to their original shapes and are electrically disconnected from each other.

As shown in FIG. 4, the electric sliding door apparatus 1 according to the present embodiment is controlled by the door ECU 61, which functions as a control section. The door ECU 61 includes a ROM (Read Only Memory) and a RAM (Random Access Memory) and functions as a microcomputer. The door ECU 61 is located, for example, in the vicinity of the slide actuator 25, and supplied with electricity from the battery (not shown) of the vehicle 2. Based on various signals sent from the operation switch 31, the position detector 27, and the current passage detecting portion 58, the door ECU 61 controls the slide actuator 25.

Operation of the electric sliding door apparatus 1 will now be described.

When receiving an opening signal from the operation switch 31, the door ECU 61 drives the slide actuator 25 to perform an opening operation of the door panel 5. Based on a position detection signal sent from the position detector 27, the door ECU 61 monitors the position of the door panel 5. In the present embodiment, the door ECU 61 counts the number of pulses of the position detection signal, and monitors the position of the door panel 5 based on the count value. When the door panel 5 is at a full open position Po, where it fully opens the entry/exit opening 4 (see FIG. 2), the door ECU 61 stops the slide actuator 25.

In contrast, when receiving a closing signal from the operation switch 31, the door ECU 61 drives the slide actuator 25 to perform a closing operation of the door panel 5. When the door panel 5 is at a fully closed position Pc, where it fully closes the entry/exit opening 4 (see FIG. 2), the door ECU 61 stops the slide actuator 25. If an object X contacts the foreign object detection sensor 51 and applies pressing force to the foreign object detection sensor 51 while the door panel 5 is being closed, the hollow insulator 52 is elastically deformed so that the pair of detection electrodes 53, 54 contact each other and are short-circuited. As a result, the value of the current supplied to the detection electrode 53 changes and the current passage detecting portion 58 outputs a contact detection signal to the door ECU 61. When receiving a contact detection signal, the door ECU 61 reverses the slide actuator 25, thereby opening the door panel 5 by a predetermined amount and then stops the slide actuator 25.

A method for manufacturing the door trim 40 will now be described. Through extrusion, the sensor holding portion 44 of the sensor portion 42, the base 41, and the locking projections 43 of the door trim 40 are integrally formed. That is, when the extrusion is finished, the locking projections 43 are continuous along the entire length of the door trim 40 as shown in FIG. 6A. In FIG. 6A, the continuous portion is denoted by L. After the extrusion, unnecessary parts except for parts corresponding to the locking projections 43 are removed from the continuous portion L. Accordingly, a plurality of locking projections 43 are formed at equal intervals in the longitudinal direction of the door trim 40. Thereafter, the foreign object detection sensor 51 is installed in the hollow portion 44a of the sensor holding portion 44.

Operation of the above described embodiment will now be described.

As shown in FIG. 3, the door trim 40 has integrally formed locking projections 43 for being attached to the trim attaching part 5b, and the locking projections 43 are arranged along the longitudinal dimension at predetermined intervals. Therefore, since the locking projections 43 are formed avoiding the curved section R of the trim attaching part 5b in the present embodiment, the door trim 40 can be easily attached to the trim attaching part 5b while ensuring the attachment strength.

In the present embodiment, since the locking projections 43, which are directly locked to the trim attaching part 5b, are integrally formed with the door trim 40, no intervening members such as clips for being placed between the door trim 40 and the trim attaching part 5b are required. Therefore, since no intervening members such as clips need to be installed in the door trim 40, the manufacturing procedure is simplified, and the number of components is limited.

Next, advantages of the present embodiment will be described.

(1) The door trim 40 is attached along the trim attaching part 5b of the door panel 5, which opens and closes an opening (entry/exit opening 4). When the door panel 5 is in a closed state, the door trim 40 is located between the door panel 5 and the center pillar 7. The door trim 40 has integrally formed locking projections 43 for being attached to the trim attaching part 5b, and the locking projections 43 are arranged along the longitudinal dimension at predetermined intervals. The locking projections 43 are not located at the curved section R of the trim attaching part 5b, so the door trim 40 can be easily attached to the trim attaching part 5b while ensuring the fastening strength.

(2) Since the door trim 40 is formed by a resin member subjected to extrusion, the locking projections 43, which are integrally formed with the door trim 40, can be formed easily.

(3) Since the locking projections 43, which are directly locked to the trim attaching part 5b, are integrally formed with the door trim 40, no intervening members such as clips for being placed between the door trim 40 and the trim attaching part 5b are required. Therefore, since no intervening members such as clips, which are separate members, need to be installed in the door trim 40, the manufacturing procedure is simplified, and the number of components is limited.

(4) After the door trim 40 is extruded, unnecessary parts except for the parts corresponding to the locking projections 43 are removed from the continuous portion L, which includes the locking projections 43, so that the locking projections 43 are formed. Therefore, the locking projections 43 are easily formed at positions at predetermined intervals in the longitudinal direction of the door trim 40.

(5) Since the rear end face (the flat end face 41a) of the base 41 of the door trim 40 faces the trim attaching part 5b in the forward-rearward direction of the vehicle, the door trim 40 is prevented from chattering.

The embodiment of the present invention may be modified as follows.

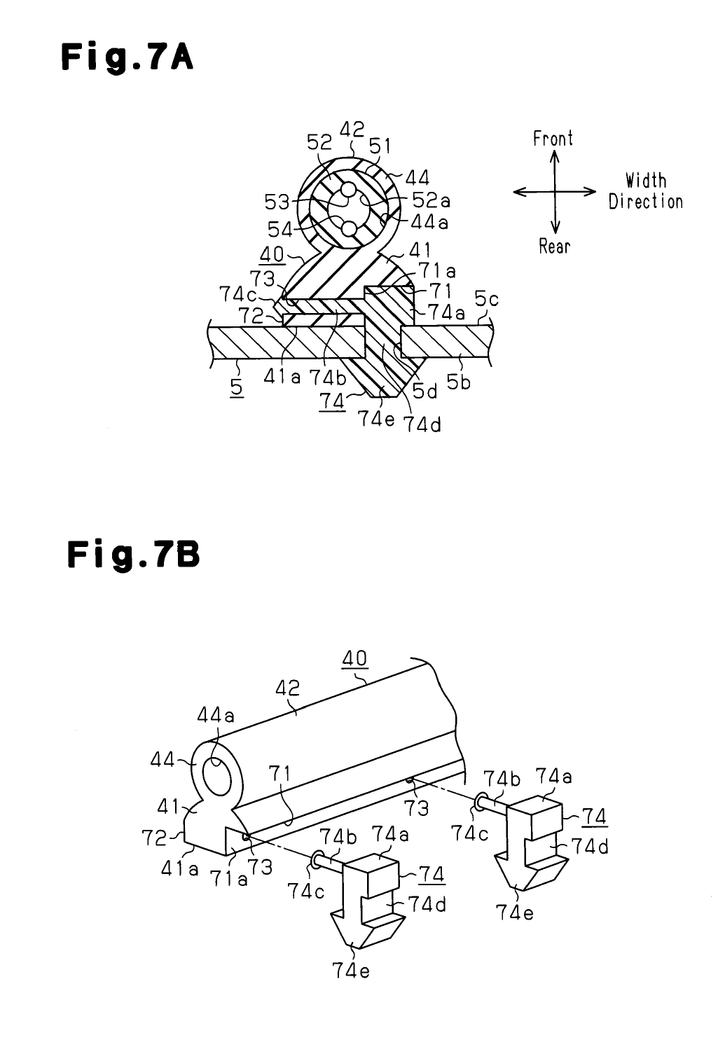

In the above illustrated embodiment, attaching portions for being attached to the trim attaching part 5b are the locking projections 43. However, the present invention is not limited to these. For example, the structures illustrated in FIGS. 7A, 7B, 8A, 8B, 9A, and 9B may be used.

According to the structure illustrated in FIGS. 7A and 7B, an attaching recess 71 is formed in one side in the width direction of the base 41 of the door trim 40, or on the right side as viewed in FIG. 7A. The attaching recess 71 has a flat contact surface 71a that is orthogonal to the vehicle width dimension. The contact surface 71a is slightly offset from the center in the width direction of the door trim 40, that is, rightward as viewed in FIG. 7A. Also, a flat surface 72 is orthogonal to the vehicle width dimension, is formed on the side of the base 41 opposite to the side on which the attaching recess 71 is formed. A plurality of attaching holes 73, which define attaching portions and have a circular cross-section, are formed in the base 41. The attaching holes 73 extend along the vehicle width dimension and through the base 41 from the contact surface 71a of the attaching recess 71 to the flat surface 72. The attaching holes 73 are arranged at equal intervals along the longitudinal dimension of the door trim 40.

A plastic clip 74 is attached to each attaching hole 73 of the door trim 40. The clips 74 are intervening members between the door trim 40 and the trim attaching part 5b. Each clip 74 has a base portion 74a, which is attached to the corresponding attaching recess 71. A front end face of the base portions 74a contacts the attaching recess 71 of the base, and a rear end face of the base portion 74a contacts the attaching surface 5c of the trim attaching part 5b. Accordingly, the attaching recess 71 of the base 41 of the door trim 40 is supported by the base portions 74a of the clips 74 in the forward-rearward direction of the vehicle. A columnar insertion portion 74b extends in the vehicle width from the base portion 74a. The insertion portions 74b are passed through the attaching holes 73 of the base 41. A locking flange 74c is formed at the distal end of the insertion portion 74b, which projects from the attaching hole 73. The locking flange 74c is locked to the flat surface 72 of the base 41 in the width direction, which prevents the insertion portion 74b from escaping from the attaching hole 73.

Each clip 74 has an extended portion 74d extending toward the rear of the vehicle from the base portion 74a and a locking portion 74e formed at the distal end of the extended portion 74d. The extended portion 74d and the locking portion 74e have the same shapes as the extended portion 43a and the locking portion 43b of the above illustrated embodiment, and are inserted into and fixed to the locking hole 5d of the trim attaching part 5b. In this manner, the door trim 40 is fixed to the trim attaching part 5b via the clips 74 attached to the attaching holes 73.

In the structure shown in FIGS. 7A and 7B, the attaching holes 73, which is used for being attached to the trim attaching part 5b, are formed at predetermined intervals long the longitudinal direction of the door trim 40. Thus, the same advantages as the above described embodiment are achieved.

In a structure in which intervening members (the clips 74) are provided between the door trim 40 and the trim attaching part 5b, a gap in the vehicle forward-rearward direction is formed between the attaching recess 71 and the trim attaching part 5b at sections where the clips 74 are not provided (each section between adjacent clips 74 in the longitudinal direction). The gaps may cause the door trim 40 to be flexed toward the rear of the vehicle. In this respect, in the configuration shown in FIGS. 7A and 7B, the dimension of the attaching recess 71 in the vehicle width direction is less than half that of the base 41, and the clips 74 are attached to positions offset in the vehicle width direction from the center of the base 41. Thus, the center in the vehicle width direction of the flat end face 41a of the base 41, that is, a portion of the sensor portion 42 closer to the rear of the vehicle, contacts the trim attaching part 5b along the entire length of the door trim 40 in the vehicle forward-rearward direction. Therefore, for example, when a pressing force in the forward-rear direction is applied to the door trim 40 to crush the sensor portion 42, the sensor portion 42 is prevented from being flexed toward the rear of the vehicle, together with the door trim 40. This enables stable detection of foreign objects by the sensor portion 42.

The attaching holes 73 of the present embodiment are successively formed in the width direction during the extrusion of the door trim 40 with a jig (not shown). Since the attaching holes 73 are formed simultaneously with the extrusion of the door trim 40, the manufacturing procedure of the door trim 40 is simplified.

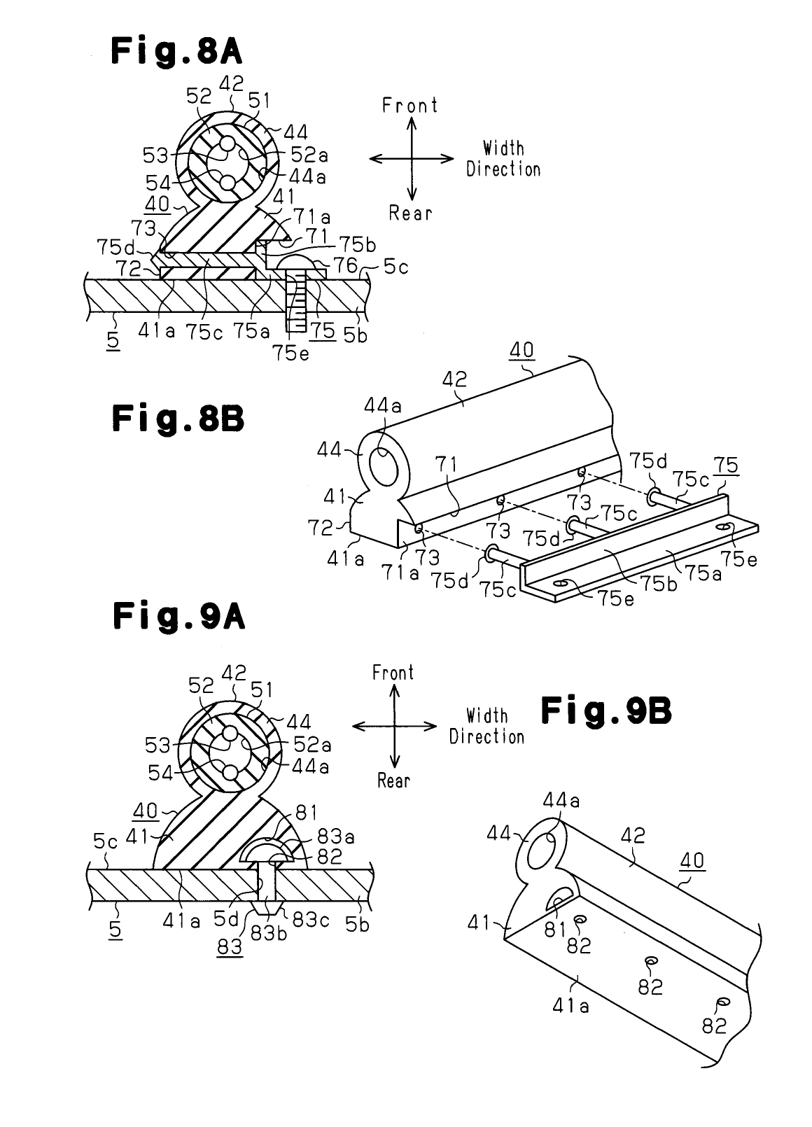

In the structure shown in FIGS. 8A and 8B, the clips 74 in the structure shown in FIGS. 7A and 7B are replaced, for example, by a metal bracket 75 (intervening member). Thus, like or the same reference numerals are given to those components that are like or the same as the corresponding components of the structure shown in FIGS. 7A and 7B, and the detailed description thereof will be omitted.

The bracket 75 shown in FIGS. 8A and 8B is L-shaped with a first plate portion 75a, which is parallel with the vehicle width direction, and a second plate portion 75b, which is perpendicular to the vehicle width direction. The second plate portion 75b has columnar insertion portions 75c extending in the vehicle width direction. In the modification shown in FIGS. 8A and 8B, three insertion portions 75c are arranged along the longitudinal dimension of the door trim 40. The dimension of the door trim 40 in the longitudinal direction is slightly longer than twice the dimension between the attaching holes 73 in the longitudinal direction. The insertion portions 75c are passed through the attaching holes 73 of the base 41. A locking flange 75d is formed at the distal end of the insertion portion 75c, which projects from the attaching hole 73. The locking flange 75d is locked to the flat surface 72 of the base 41 in the vehicle width direction, which prevents the insertion portion 75c from coming off the attaching hole 73.

The first plate portion 75a of the bracket 75 has two insertion holes 75e, and screws 76 inserted in the insertion holes 75e are fastened to the trim attaching part 5b. This fixes the door trim 40 to the trim attaching part 5b with the bracket 75 in between. This configuration provides substantially the same advantages as the configuration shown in FIGS. 7A and 7B.

In a structure illustrated in FIGS. 9A and 9B, the base 41 has a hollow portion 81, which extends continuously in the entire longitudinal direction. The hollow portion 81 is offset in the vehicle width direction from the center the base 41. A plurality of attaching holes 82, which define attaching portions, are formed in the flat end face 41a (the rear end face) of the base 41. The attaching holes 82 extend in the vehicle forward-rearward direction to communicate with the hollow portion 81. The attaching holes 82 are arranged at equal intervals along the longitudinal dimension of the door trim 40.

A clip 83, which is an intervening member, is attached to each attaching hole 82. Each clip 83 has a head 83a, which is fitted into the hollow portion 81, an extended portion 83b, which extends toward the rear of the vehicle from the head 83a, and a locking flange 83c, which is provided at distal end of the extended portion 83b, that is, at the end opposite to the head 83a. The head 83a is locked to the inner surface of the hollow portion 81 to prevent the clip 83 from falling off the attaching hole 82. The extended portion 83b is passed through the corresponding attaching hole 82 of the door trim 40 and the corresponding locking hole 5d of the trim attaching part 5b. The locking flange 83c, which protrudes toward the rear of the vehicle from the locking hole 5d, is locked to the back side of the trim attaching part 5b, that is, locked to the end face opposite to the attaching surface 5c. This fixes the door trim 40 to the trim attaching part 5b with the clips 83 attached to the attaching holes 82. This configuration provides substantially the same advantages as the configuration shown in FIGS. 7A and 7B. Although the hollow portion 81 extends continuously along the entire longitudinal dimension, a plurality of hollow portions 81 may be formed to correspond to each of the attaching holes 82. This structure further effectively prevents the door trim 40 from flexing toward the rear of the vehicle.

In the above described embodiment, the locking projections 43 (attaching portions) are formed at equal intervals along the longitudinal dimension of the door trim 40. However, the locking projections 43 may be formed at unequal intervals. Also, in the structures shown in FIGS. 7A to 9B, the attaching holes 73, 82, which define attaching portions, may be arranged at unequal intervals along the longitudinal dimension.

In the above illustrated embodiment, the locking projections 43 are formed on the door trim 40, and the locking holes 5d, which are locked to the locking projections 43, are formed in the trim attaching part 5b. However, the positions of these projections and holes may be reversed.

In the illustrated embodiment, the door trim 40 is formed through extrusion. However, the door trim 40 may be formed through other method, for example, injection molding.

In the illustrated embodiment, the foreign object detection sensor 51 is formed by a pressure sensitive sensor. However, the foreign object detection sensor 51 may be formed, for example, by a proximity sensor. A configuration may be employed in which a foreign object detection sensor 51 that uses a pressure sensitive sensor and a proximity sensor together to detect a foreign object X.

In the illustrated embodiment, the foreign object detection sensor 51 is provided in the door trim 40. However, the foreign object detection sensor 51 may be omitted. For example, the sensor holding portion 44 may be replaced by a columnar portion (protector portion) having no hollow portion 44a.

The door trim 40 of the above embodiment may be formed of a plastic material other than rubber.

In the above embodiment, a foreign object detection sensor is provided on the slidable door panel 5, which selectively opens and closes an opening (the entry/exit opening 4) formed in a side of a vehicle. However, a foreign object detection sensor may be provided on a door panel 5 that is selectively opens and closes an opening at the back of the vehicle (tailgate). A foreign object detection sensor may be provided on a part of the vehicle body that faces the door panel 5 (on the edge of the opening).

In the above embodiment, a foreign object detection sensor is provided in the slidable door panel 5. However, a foreign object detection sensor may be provided in a door panel 5 that is rotational relative to the vehicle body 3, for example, via hinges.

In the above embodiment, the door trim 40 is provided on the door panel 5. In addition, another door trim 40 may be provided on the center pillar 7. In that case, the trim attaching part 5b is provided on the center pillar 7. Alternatively, a door trim 40 may be provided only on the center pillar 7.

In the above embodiment, the door trim 40 is fixed to the door panel 5 by means of the locking projections 43, which are integrally formed with the base 41 of the door trim 40. However, the door trim 40 may be fixed by a bonding member in addition to the locking projections 43.

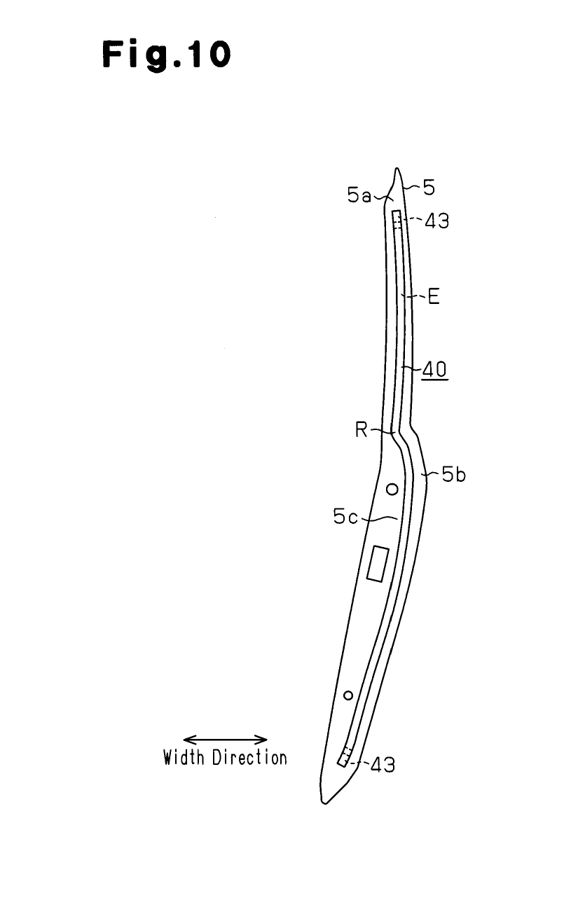

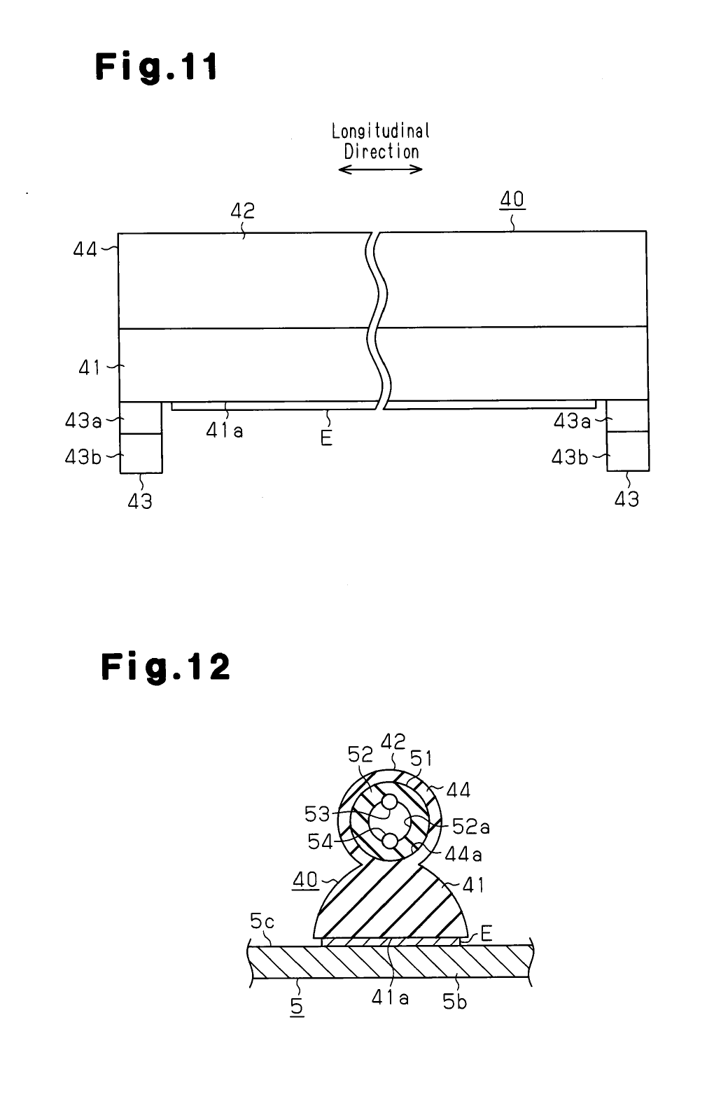

For example, in a configuration shown in FIGS. 10, 11, and 12, a locking projection 43 (the same configuration as the above embodiment) is formed on either end in the longitudinal direction of the base 41 of the door trim 40. Each locking projection 43 projects toward the rear of the vehicle from the flat end face 41a of the base 41. As in the above embodiment, each locking projection 43 is inserted in and locked to a locking hole 5d of the trim attaching part 5b (refer to FIG. 5). A center portion in the longitudinal direction of the flat end face 41a of the base 41, that is, a part between the locking projections 43 is fixed to the attaching surface 5c of the trim attaching part 5b by a bonding member E. The bonding member E may be a double-sided tape or adhesive.

According to this configuration, the door trim 40 is fixed not only by the locking projections 43, but also by the bonding member E. Thus, the attachment strength is improved by bonding, which is an easy method. By using the bonding member E for fixation at the curved section R of the door trim 40, where no locking projections 43 are formed, the attachment strength is improved without reducing the ease of attachment of the door trim 40. Also, in the configuration shown in FIGS. 10 to 12, the locking projections 43 are provided only at the longitudinal ends of the door trim 40, and the remaining middle portion in the longitudinal direction is bonded by the bonding member E. According to this configuration, the longitudinal ends of the door trim 40 are firmly fixed by the locking projections 43 to prevent the door trim 40 from peeling and falling at the longitudinal ends, while facilitating the fixation of the door trim 40 in the middle portion in the longitudinal direction.

Although one locking projection 43 is provided at each end in the longitudinal direction of the door trim 40 in the configuration of FIGS. 10 to 12, the present invention is not limited to this. Another locking projection 43 may be added in the middle portion in the longitudinal direction, so that there are total of three locking projections 43. Alternatively, four or more locking projections 43 may be provided. Also, the locking projections 43 do not necessarily have to be provided at the longitudinal ends, but may be omitted. The fixing structure by the bonding member E may be applied to the configurations shown in FIGS. 7A to 9B.

Therefore, the present examples and embodiments are to be considered as illustrative and not restrictive and the invention is not to be limited to the details given herein, but may be modified within the scope and equivalence of the appended claims.

1. An elongated vehicle door trim adapted for being attached to a vehicle that has a fixed body having an opening and a movable body for opening and closing the opening, wherein
the door trim is attached along a trim attaching part of at least one of the fixed body and the movable body,
when the movable body is in a closed state, the door trim is located between the movable body and the fixed body,
the door trim comprises a plurality of attaching portions for being attached to the trim attaching part, and
the attaching portions are arranged along a longitudinal dimension of the door trim at predetermined intervals and formed integrally with the door trim.

2. The vehicle door trim according to claim 1, wherein the door trim is formed of an extruded plastic material.

3. The vehicle door trim according to claim 1, further comprising a sensor holding portion that holds a foreign object detection sensor for detecting a foreign object between the movable body and the fixed body, wherein the sensor holding portion is formed integrally with the door trim.

4. The vehicle door trim according to claim 1, wherein the attaching portions are each locked to the trim attaching part.

5. The vehicle door trim according to claim 1, wherein
the door trim is attached to the door trim attaching part via intervening members, each of which is attached to one of the attaching portions,
a middle portion of the door trim with respect to the vehicle width direction is brought into contact with the trim attaching part, and
the intervening members are offset in the vehicle width direction from the center of the door trim in the vehicle width direction.

6. The vehicle door trim according to claim 1, wherein a bonding member for bonding the door trim to the door trim attaching part is provided on a part of the door trim between the attaching portions.

7. A method for manufacturing an elongated vehicle door trim adapted for being attached to a vehicle that has a fixed body having an opening and a movable body for opening and closing the opening, wherein the door trim is adapted for being attached along a trim attaching part of at least one of the fixed body and the movable body such that when the movable body is in a closed state, the door trim is located between the movable body and the fixed body,
the method comprising forming a plurality of attaching portions for being attached to the trim attaching part such that the attaching portions are formed integrally with the door trim and such that the attaching portions are arranged along a longitudinal dimension of the door trim at predetermined intervals.

8. The method for manufacturing a vehicle door trim according to claim 7, wherein the door trim is formed by extruding a plastic material.

9. The method for manufacturing a vehicle door trim according to claim 8, wherein
the attaching portions are locking projections, which are adapted to be directly locked to the trim attaching part, and
the method further comprising, after forming the door trim through extrusion, removing unnecessary parts except for the parts corresponding to the locking projections from a continuous portion that includes the locking projections, thereby forming the locking projections.

10. The method for manufacturing a vehicle door trim according to claim 7, wherein a part of the door trim between the attaching portions is bonded to the door trim attaching part using a bonding member.
